(19) United States
(12) Patent Application Publication
(10) Pub. No.: US 2026/0020532 A1
(43) Pub. Date: Jan. 22, 2026

(54) Finger-mounted garden trimmer assembly

(71) Applicant: Kevin Alvarez, Los Angeles, CA (US)

(72) Inventor: Kevin Alvarez, Los Angeles, CA (US)

(21) Appl. No.: 18/778,160

(22) Filed: Jul. 19, 2024

(51) Int. Cl. A01G 3/02; B26B 27/00

(52) U.S. Cl. CPC A01G 3/021; B26B 27/007

(57) ABSTRACT

A finger-mounted garden trimmer assembly includes first and second pairs of scissors, each including a first blade and a second blade connected together by a scissor axle, first, second, and third finger support sleeves, each designed to fit onto a human finger, and first, second, and third blade-mounting structures, one each attached to the first, second, and third finger support sleeves. The first blade-mounting structure is pivotably connected to a pivot end of the first blade of the first pair of scissors. The second blade-mounting structure is pivotably connected to a pivot end of the second blade of the second pair of scissors. The third blade-mounting structure is positioned between the first and second blade-mounting structures and is pivotably connected to a pivot end of the second blade of the first pair of scissors and to a pivot end of the first blade of the second pair of scissors.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to garden trimmers and more particularly pertains to a new finger-mounted garden trimmer assembly for allowing a user to trim plants with one hand with less fatigue and effort, which trimmer assembly includes two pairs of scissors.

### (2) Description of Related Art Including Information Disclosed Under 37 CFR 1.97 and 1.98

The prior art relates to garden trimmers. The prior art, as best understood, does not disclose a finger-mounted garden trimmer assembly that includes first and second pairs of scissors, first, second, and third finger support sleeves, each designed to fit onto a human finger, and first, second, and third blade-mounting structures, one each attached to the first, second, and third finger support sleeves.

### BRIEF SUMMARY OF THE INVENTION

An embodiment of the disclosure meets the needs presented above in a finger-mounted garden trimmer assembly generally comprising first and second pairs of scissors, first, second, and third finger support sleeves, each designed to fit onto a human finger, and first, second, and third blade-mounting structures, one each attached to the first, second, and third finger support sleeves. Each of said first and second pairs of scissors includes a first blade and a second blade connected together by a scissor axle. The first blade-mounting structure is pivotably connected to a pivot end of the first blade of the first pair of scissors. The second blade-mounting structure is pivotably connected to a pivot end of the second blade of the second pair of scissors. The third blade-mounting structure is positioned between the first and second blade-mounting structures and is pivotably connected to a pivot end of the second blade of the first pair of scissors and to a pivot end of the first blade of the second pair of scissors.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear perspective view of a finger-mounted garden trimmer assembly according to an embodiment of the disclosure.

FIG. 2 is a front perspective view of an embodiment of the disclosure.

FIG. 3 is an exploded view of an embodiment of the disclosure.

FIG. 4 is a front closed view of an embodiment of the disclosure.

FIG. 5 is a perspective view of an embodiment of the disclosure in use.

### DETAILED DESCRIPTION OF THE INVENTION

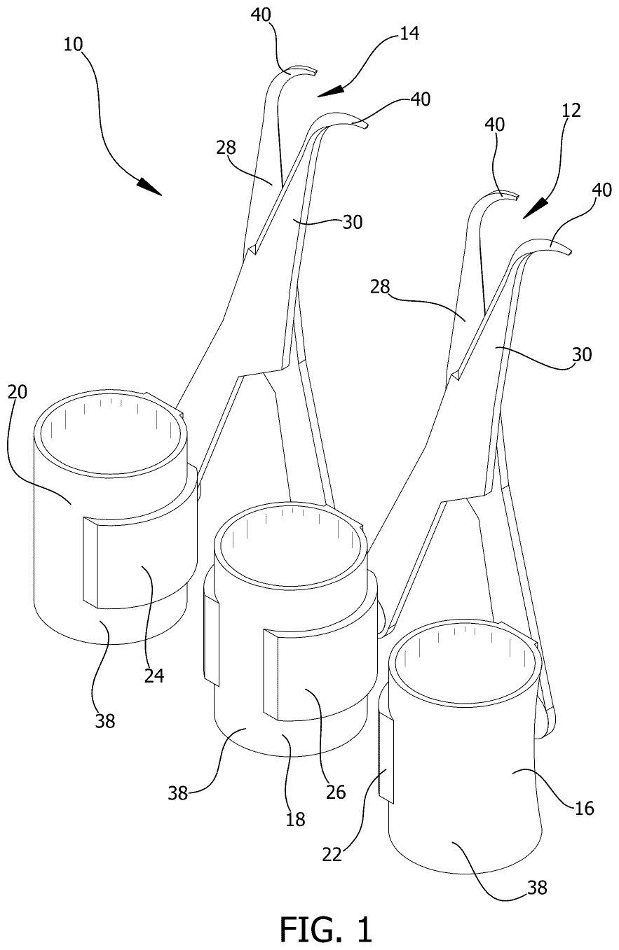

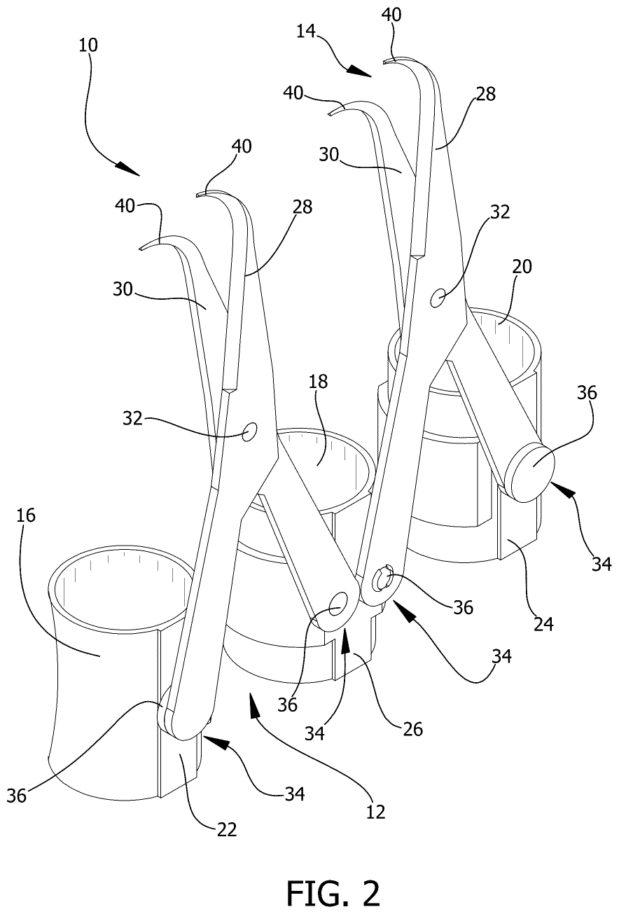

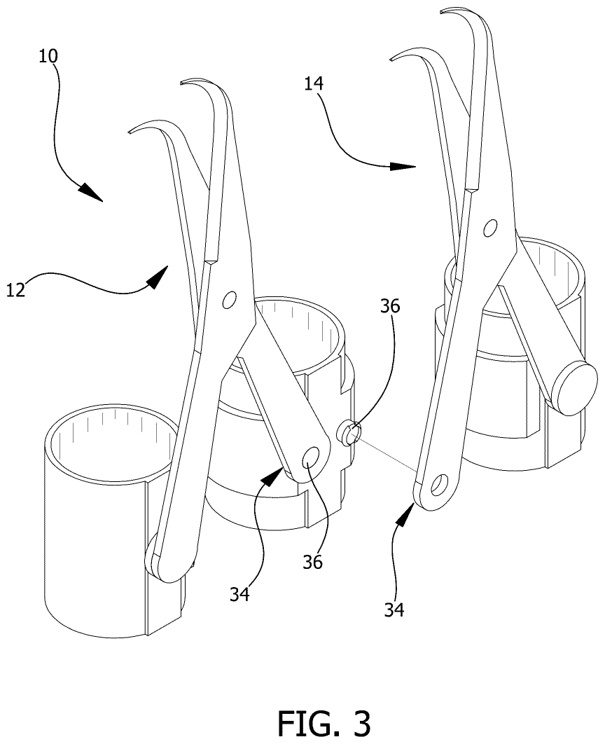

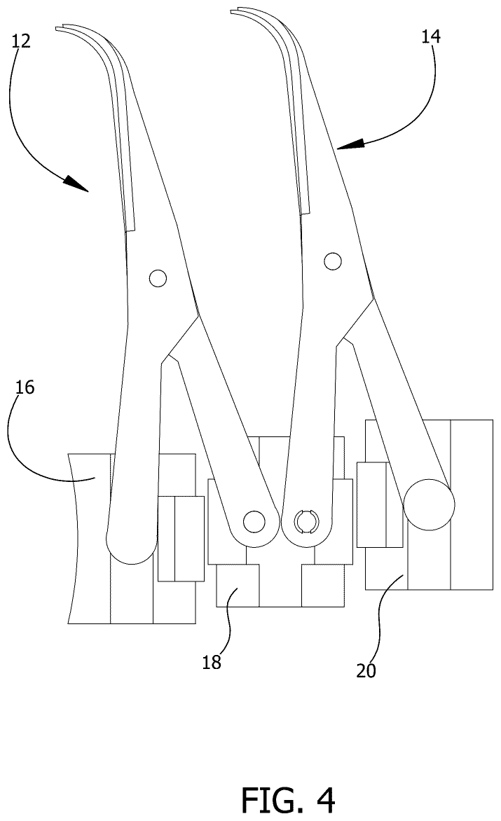

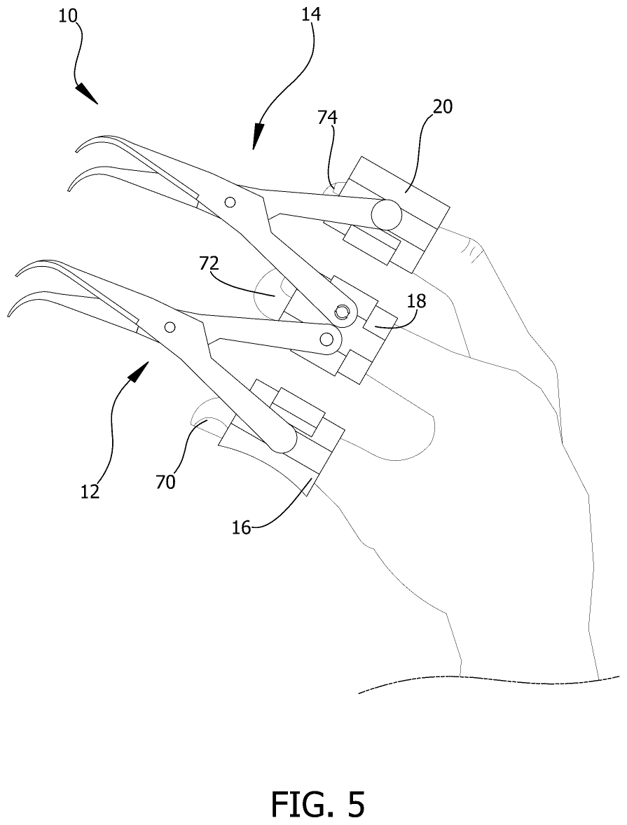

With reference now to the drawings, and in particular to FIGS. 1 through 5 thereof, a new finger-mounted garden trimmer assembly embodying the principles and concepts of an embodiment of the disclosure and generally designated by the reference numeral 10 will be described.

As best illustrated in FIGS. 1 through 5, the finger-mounted garden trimmer assembly 10 generally comprises first and second pairs of scissors 12, 14, first, second, and third finger support sleeves 16, 18, 20, collectively referred to herein as finger support sleeves 38, each designed to fit onto a human finger, and first, second, and third blade-mounting structures 22, 24, 26, one each attached to the first, second, and third finger support sleeves 16, 18, 20. Each of said first and second pairs of scissors 12, 14 includes a first blade 28 and a second blade 30 connected together by a scissor axle 32. The first blade-mounting structure 22 is pivotably connected to a pivot end 34 of the first blade 28 of the first pair of scissors 12. The second blade-mounting structure 24 is pivotably connected to a pivot end 34 of the second blade 30 of the second pair of scissors 14. The third blade-mounting structure 26 is positioned between the first and second blade-mounting structures 22, 24 and is pivotably connected to a pivot end 34 of the second blade 30 of the first pair of scissors 12 and to a pivot end 34 of the first blade 28 of the second pair of scissors 14.

As shown in FIG. 1, each of the first, second, and third blade-mounting structures 22, 24, 26 has a pivot post 36 or similar structure connected to the pivot ends 34 of the first and second pairs of scissors 12, 14. The third blade-mounting structure 26 has two separate pivot posts 36, though in another possible embodiment third blade-mounting structure 26 could have a single pivot post 36 common to each of the pivot ends 34 of the second blade 30 of the first pair of scissors 12 and the first blade 28 of the second pair of scissors 14.

Each of the finger support sleeves 38 is cylindrical. However, in another possible embodiment, the finger support sleeves 38 could have a slot or opening therein, such that the finger support sleeves 38 have a C-shape. In one possible embodiment, each of the finger support sleeves 38 is made of a resiliently elastic material, which ensures a snug but comfortable fit on the fingers. In another possible embodiment, the finger support sleeves 38 may be made of plastic, such as a softer plastic that provides stability but is also comfortable, or a harder plastic that may not be as comfortable as the softer plastic but would provide increased stability and transfer of forces to the first and second pairs of scissors 12, 14.

The finger support sleeves 38 could each be of one size and diameter. However, in one possible embodiment, the first, second, and third finger support sleeves 16, 18, 20 are sized to fit onto a thumb 70, index finger 72, and middle finger 74, respectively, of a human hand. In other words, the first support sleeve 16 could be larger to fit on a thumb 70 and the second support sleeve 18 could be smaller to fit on an index finger 72. In such a situation, the finger-mounted garden trimmer assembly 10 could be customized for left-handed and right-handed users.

In one possible embodiment, each of the first and second blades 28, 30 includes a curved tip 40. The curved tip 40 assists in gathering and snipping small pieces of a plant.

While first and second pairs of scissors 12, 14 are shown in the exemplary embodiment connected to three fingers, in another possible embodiment three pairs of scissors could be connected to four fingers, or even four pairs of scissors could be connected to all five fingers.

The finger-mounted garden trimmer assembly 10 can be used to trim parts of plants, though it is best suited for smaller garden or house plants, while allowing the user to have his or her other hand free to do other tasks, though the user could also wear one finger-mounted garden trimmer assembly 10 on one hand and one on the other. The user first places each of the first, second, and third finger support sleeves 16, 18, 20 onto a human finger, which in the exemplary embodiment shown are the thumb 70, the index finger 72, and the middle finger 74. The user then moves adjacent human fingers towards and away from one another and thereby causes the first and second pairs of scissors 12, 14 mounted thereon to close and open, either one at a time or simultaneously, to engage and trim a portion of a plant.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items 10 following the word are included, but items not specifically mentioned are not excluded. A reference to an element by the indefinite article “a” does not exclude the possibility that more than one of the element is present, unless the context clearly requires that there be only one of the elements.

I claim:

1. A finger-mounted garden trimmer assembly comprising:
first and second pairs of scissors, each comprising a first blade and a second blade connected together by a scissor axle;
first, second, and third finger support sleeves, each configured to fit onto a human finger; and
first, second, and third blade-mounting structures, one each attached to said first, second, and third finger support sleeves, wherein:
said first blade-mounting structure is pivotably connected to a pivot end of said first blade of said first pair of scissors,
said second blade-mounting structure is pivotably connected to a pivot end of said second blade of said second pair of scissors,
said third blade-mounting structure is disposed between said first and second blade-mounting structures and is pivotably connected to a pivot end of said second blade of said first pair of scissors and to a pivot end of said first blade of said second pair of scissors.

2. The finger-mounted garden trimmer assembly of claim 1, wherein each of said first and second blades comprises a curved tip.

3. The finger-mounted garden trimmer assembly of claim 1, wherein each of said finger support sleeves is cylindrical.

4. The finger-mounted garden trimmer assembly of claim 1, wherein each of said finger support sleeves comprises a resiliently elastic material.

5. The finger-mounted garden trimmer assembly of claim 1, wherein said first, second, and third finger support sleeves are sized to fit onto a thumb, index finger, and middle finger, respectively, of a human hand.

6. A method of using the finger-mounted garden trimmer assembly of claim 1, comprising the steps of:
placing each of said first, second, and third finger support sleeves onto a human finger; and
moving adjacent human fingers towards and away from one another and thereby causing said first and second pairs of scissors mounted thereon to close and open, either one at a time or simultaneously, to engage and trim a portion of a plant.

7. A finger-mounted garden trimmer assembly comprising:
first and second pairs of scissors, each comprising a first blade and a second blade connected together by a scissor axle, wherein:
each of said first and second blades comprises a curved tip;
first, second, and third finger support sleeves, each configured to fit onto a human finger, wherein:
each of said finger support sleeves is cylindrical,
each of said finger support sleeves comprises a resiliently elastic material,
said first, second, and third finger support sleeves are sized to fit onto a thumb, index finger, and middle finger, respectively, of a human hand; and
first, second, and third blade-mounting structures, one each attached to said first, second, and third finger support sleeves, wherein:
said first blade-mounting structure is pivotably connected to a pivot end of said first blade of said first pair of scissors,
said second blade-mounting structure is pivotably connected to a pivot end of said second blade of said second pair of scissors,
said third blade-mounting structure is disposed between said first and second blade-mounting structures and is pivotably connected to a pivot end of said second blade of said first pair of scissors and to a pivot end of said first blade of said second pair of scissors.
